(19) United States
(12) Patent Application Publication
(10) Pub. No.: US 2025/0377267 A1
(43) Pub. Date: Dec. 11, 2025

(54) SAMPLING CONTROL METHOD AND DEVICE

(71) Applicant: NEW-FAST TECHNOLOGY CO., LTD., Hsinchu County (TW)

(72) Inventors: Yu-Ying CHU, Hsinchu County (TW); Jen-Te LIAO, Hsinchu County (TW)

(21) Appl. No.: 18/906,812

(22) Filed: Oct. 4, 2024

(30) Foreign Application Priority Data
Jun. 5, 2024 (TW) 113120880

(51) Int. Cl. G01N 1/10; G01N 35/00

(52) U.S. Cl. CPC G01N 1/10; G01N 35/0099; G01N 35/00732

(57) ABSTRACT

A sampling control method is disclosed, which includes: controlling an actuator to drive a gripper to rotate; controlling the actuator to drive the gripper horizontally moving to adjust a horizontal position of the gripper to a horizontal target position in a placement position; controlling the actuator to drive the gripper vertically moving to grip a cap of a sample bottle; controlling the actuator to drive the gripper to rotate so that makes a setting direction of the gripper to be perpendicular to a setting direction of a detector bar; controlling the actuator to drive the detector bar horizontally moving to adjust a horizontal position of the detector bar to the horizontal target position; and controlling the actuator to drive the detector bar vertically moving to adjust a height of the detector bar to a liquid level for sampling.

### BACKGROUND OF THE DISCLOSURE

### Technical Field

The disclosure relates to techniques for sampling trace elements, particularly relates to a sampling control method and device.

### Description of Related Art

When detecting trace elements at present, existing trace element detectors such as those used in the semiconductor industry often require human operation (e.g., sampling), which tends to increase chances of exposure to contaminants due to the human operation. Therefore, how to minimize the human operation and automate the sampling is an urgent problem to be solved by the technicians in this field.

### SUMMARY OF THE DISCLOSURE

The purpose of the disclosure is to provide a sampling control method and a device that automates sampling by reducing human operation.

In order to achieve the above purpose, the disclosure provides the sampling control method for a detection device including a chamber and an actuator, where the sampling control method includes:
by a processor, controlling the actuator to drive a gripper on a lift arm in the actuator to rotate centered on a pivot in the actuator from a starting position so that makes a first setting direction of the gripper parallel to a second setting direction of a detector bar on the lift arm;
by the processor, controlling the actuator to drive the gripper horizontally moving to adjust a first horizontal position of the gripper to a horizontal target position in a placement position, wherein the placement position is a position of a sample bottle in the chamber;
by the processor, controlling the actuator to drive the gripper vertically moving to adjust a first vertical position of the gripper to a vertical target position in the placement position, and controlling the gripper to grip a cap of the sample bottle;
by the processor, controlling the actuator to drive the gripper to rotate centered on the pivot so that makes the first setting direction to be perpendicular to the second setting direction;
by the processor, controlling the actuator to drive the detector bar horizontally moving to adjust a second horizontal position of the detector bar to the horizontal target position; and
by the processor, controlling the actuator to drive the detector bar vertically moving to adjust a height of the detector bar to a liquid level, and controlling the detector bar to collect a sample in the sample bottle, where the liquid level is a height of a liquid surface of the sample in the sample bottle.

In order to achieve the above purpose, the disclosure provides the sampling control device for controlling a detection device, where the detection device includes a chamber and an actuator, where the control device includes:
a memory, configured for storing a placement position of a sample bottle in the chamber and a liquid level of a sample in the sample bottle, where the placement position includes a horizontal target position and a vertical target position of the sample bottle in the chamber;
a processor, coupled to the memory, and configured for executing following steps:
controlling the actuator to drive a gripper on a lift arm in the actuator to rotate centered on a pivot in the actuator from a starting position so that makes a first setting direction of the gripper parallel to a second setting direction of a detector bar on the lift arm;
controlling the actuator to drive the gripper horizontally moving to adjust a first horizontal position of the gripper to the horizontal target position;
controlling the actuator to drive the gripper vertically moving to adjust a first vertical position of the gripper to the vertical target position, and controlling the gripper to grip a cap of the sample bottle;
controlling the actuator to drive the gripper to rotate centered on the pivot so that makes the first setting direction of the gripper to be perpendicular to the second setting direction;
controlling the actuator to drive the detector bar horizontally moving to adjust a second horizontal position of the detector bar to the horizontal target position; and
controlling the actuator to drive the detector bar vertically moving to adjust a height of the detector bar to the liquid level, and controlling the detector bar to collect a sample in the sample bottle.

compared to related technologies, the disclosure automates various rotational and translational operations of the gripper to quickly and accurately clamp the cap of a sample bottle with the gripper. Next, the sampling control method and device proposed in the disclosure decide how far the detector bar has to be moved to reach the bottle neck of the sample bottle based on the distance between the gripper and the detector bar, in order to open the cap of the bottle and move the detector bar to the bottle neck of the sample bottle. In this way, the disclosure not only greatly reduces the chance of increased exposure to contaminants due to human operation, but also achieves the effect of automating the sampling process by reducing the human operation.

### BRIEF DESCRIPTION OF THE DRAWINGS

FIG. 1 illustrates a block diagram of a control device based on computer vision in some embodiments of the disclosure.

FIG. 2 illustrates a schematic diagram of a disposed manner for a camera circuit in some embodiments of the disclosure.

FIG. 3 illustrates a flowchart of a control method based on computer vision in some embodiments of the disclosure.

FIG. 4 illustrates a schematic diagram of a top-view of a tray in some embodiments of the disclosure.

FIG. 5 illustrates a schematic diagram of an image to be tested in some other embodiments of the disclosure.

FIG. 6 illustrates a schematic diagram of an image to be tested in other embodiments of the disclosure.

FIG. 7 illustrates a flowchart of detailed steps of one step of the control method based on computer vision in some embodiments of the disclosure.

FIG. 8 illustrates a schematic diagram of multiple bounding boxes in some embodiments of the disclosure.

FIG. 9 illustrates a schematic diagram of multiple horizontal coordinates in some embodiments of the disclosure.

FIG. 10 illustrates a flowchart of a detailed step in another step of the control method based on computer vision in some embodiments of the disclosure.

FIG. 11 illustrates a flowchart of a detailed step in another step of the control method based on computer vision in some embodiments of the disclosure.

FIG. 12 illustrates a flowchart of a sampling control method in some embodiments of the disclosure.

FIG. 13 illustrates a flowchart of steps executed before the sampling control method in some embodiments of the disclosure.

FIG. 14 illustrates a schematic diagram of a starting position of a gripper in some embodiments of the disclosure.

FIG. 15 illustrates a schematic diagram of the gripper starting to rotate in some embodiments of the disclosure.

FIG. 16 illustrates a schematic diagram of horizontal movement of the gripper in some embodiments of the disclosure.

FIG. 17 illustrates a schematic diagram of the gripper gripping a cap of a sample bottle in some embodiments of the disclosure.

FIG. 18 illustrates a schematic diagram of the gripper opening the cap of the sample bottle in some embodiments of the disclosure.

FIG. 19 illustrates a flowchart of detailed steps of one step of the sampling control method in some embodiments of the disclosure.

FIG. 20 illustrates a schematic diagram of the gripper rotating the cap after the gripper clamps in some embodiments of the disclosure.

FIG. 21A illustrates a schematic diagram of a horizontal distance in some embodiments of the disclosure.

FIG. 21B illustrates a schematic diagram of adjustment of a horizontal position of a detector bar in some embodiments of the disclosure.

FIG. 22 illustrates a flowchart of a step executed after the sampling control method in some embodiments of the disclosure.

FIG. 23A illustrates a schematic diagram of vertical movement of the detector bar in some embodiments of the disclosure.

FIG. 23B illustrates a schematic diagram of the detector bar vertically moving at a moving speed in some embodiments of the disclosure.

### DETAILED DESCRIPTION

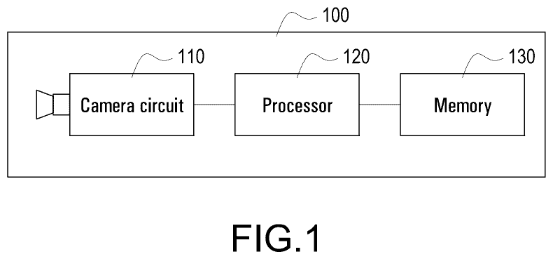

Reference is made to FIG. 1, and FIG. 1 illustrates a block diagram of a control device 100 based on computer vision in some embodiments of the disclosure. As shown in FIG. 1, the control device 100 based on computer vision of the disclosure includes a camera circuit 110 and a processor 120, where the camera circuit 110 and the processor 120 are connected to each other.

In this embodiment, the control device 100 is suitable for controlling a detection device. Specifically, the detection device is a detection device for trace elements. The detection device is an automated device for sampling and detecting the trace elements, where the detection device includes a chamber, a tray, and an actuator (to be described later). The camera circuit 110 is disposed above the tray and photographs multiple sample bottles on the tray in a top-view manner (i.e., with a photographing direction facing the tray) to generate a top-view image. In some embodiments, the camera circuit 110 is implemented by any circuit having image capture capabilities and the top-view image includes images of all sample bottles placed on the tray. In this embodiment, the camera circuit 110 and the processor 120 execute a control method based on computer vision in subsequent paragraphs. In some embodiments, the processor 120 controls movement and rotation of components in the actuator. In some embodiments, processor 120 is implemented by a central processing unit (CPU), a micro control unit (MCU), a programmable logic controller (PLC), a system on chip (SoC), a system on chip (SoC), or field programmable gate array (FPGA), but not limited thereto.

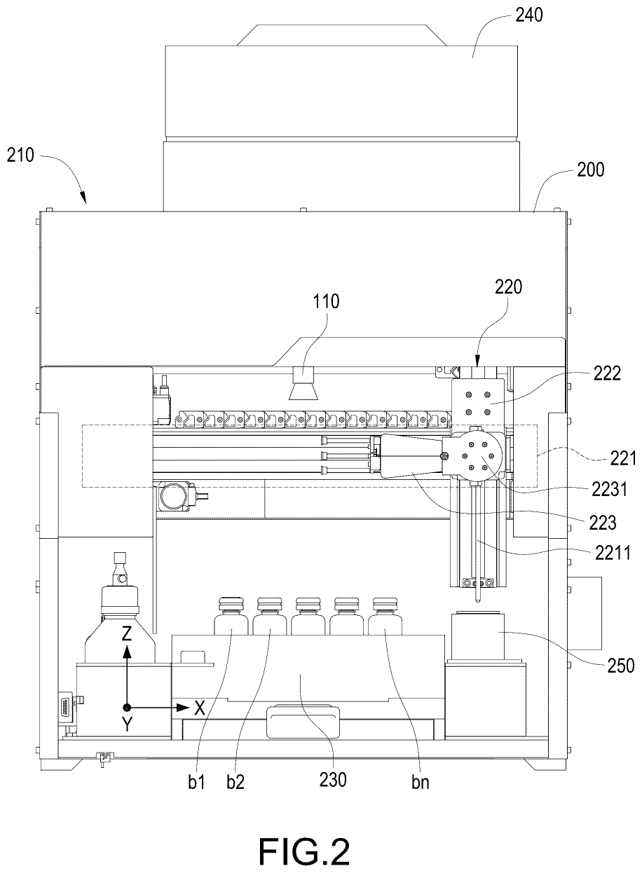

In order for understanding a structure of the detection device, control of the processor 120 to the components in the actuator, and a disposed manner of the camera circuit 110, the structure of the detection device, the control of the processor 120 to the components in the actuator, and the disposed manner of the camera circuit 110 are further explained below by a practical example. Reference is made to FIG. 2, and FIG. 2 illustrates a schematic diagram of the disposed manner of the camera circuit 110 in some embodiments of the disclosure. As shown in FIG. 2, the detection device 200 includes the chamber 210, the actuator 220, and the tray 230.

The tray 230 is disposed in the chamber 210. The tray 230 carries the multiple sample bottles b1-bn having caps, where n is a positive integer and can be further adjusted according to the requirement of a user without any particular limitation. Each of the sample bottles b1-bn contains the trace element to be detected. The actuator 220 is disposed in the chamber 210 and disposed on an upper position opposite to the tray 230. The actuator 220 includes a slide 222, a lift arm 221 sliding on the slide 222, and a gripper 223 capable of oscillating on the lift arm 221. The lift arm 221 has a detector bar 2211 for sampling, and the detector bar 2211 is disposed in a direction parallel to a Z-axis direction.

In some embodiments, the processor 120 controls the slide 222 in the actuator 220 to drive the lift arm 221 to move in an XY plane, two lateral rails in the slide 222 are respectively fixed to left and right inner walls of the chamber 210 to drive the lift arm 221 to move along a Y-axis direction, and a middle rail in the slide 222 is movably disposed between the two lateral rails to drive the lift arm 221 to move along an X-axis direction. In some embodiments, the processor 120 controls movement of the lift arm 221 in the actuator 220 along the Z-axis direction.

In some embodiments, the processor 120 controls the gripper 223 in the actuator 220 to rotate centered on a pivot 2231 (i.e., clockwise or counterclockwise rotation along the Y-axis direction) so that makes a setting direction of the gripper 223 parallel to the X-axis direction or parallel to the Z-axis direction. In some embodiments, the detection device 200 further includes a washer 250 for cleaning the detector bar 2211. In some embodiments, in an initial state (e.g., at a time point when the control device 100 has just been activated), the processor 120 controls the slide 222 in the actuator 220 to drive the lift arm 221 over the washer 250 (i.e., the detector bar 2211 of the lift arm 221 is moved to a spot just above the washer 250) to prevent the camera circuit 110 from capturing images with the lift arm 221, the gripper 223, and the detector bar 2211 inside.

In some embodiments, a photographing direction of the camera circuit 110 is towards the tray 230 and parallel to the Z-axis direction, and the camera circuit 110 is disposed above the tray 230 to photograph the entire tray 230. In this way, the top-view image captured by the camera circuit 110 includes images of the caps of all sample bottles b1-bn on the trays 230. In some embodiments, the detection device 200 further includes an extraction fan 240 for extracting air from the chamber 210. In some embodiments, the camera circuit 110 is disposed below the extraction fan 240 to photograph the entire tray 230 without having the extraction fan 240 in the captured images. In some embodiments, the camera circuit 110 is disposed at any place in the chamber 210 that is capable of photographing the entire tray 230 and having the caps of all sample bottles b1-bn in the captured images, where the photographing direction of the camera circuit 110 may or may not be parallel to the Z-axis direction.

It should be noted that coordinate axes X, Y, and Z labeled in FIG. 2 are coordinate axes of a user coordinate system. In some embodiments, the user coordinate system is a three-dimensional coordinate system that is set by the user for a space in the chamber 210.

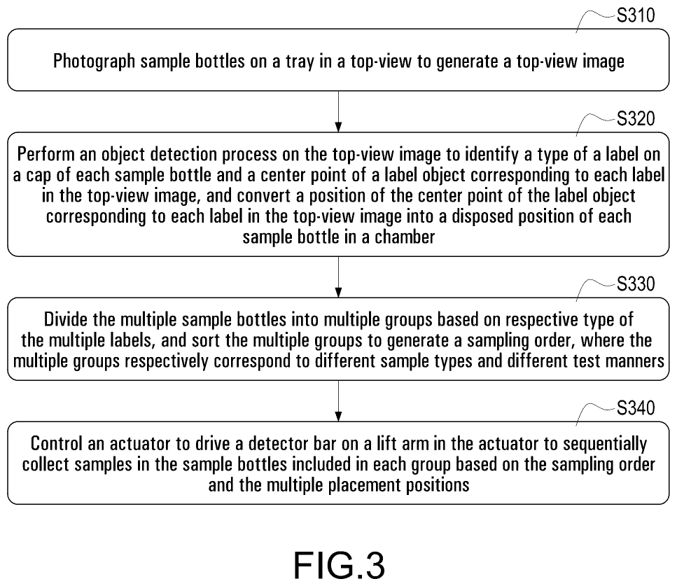

Reference is made to FIG. 3, and FIG. 3 illustrates a flowchart of a control method based on computer vision in some embodiments of the disclosure, and this control method is suitable for the control device 100 shown in FIG. 1.

As shown in FIG. 3, the control method includes steps S310-S340. First, in step S310, the camera circuit 110 photographs the sample bottles b1-bn on the trays 230 in a top-view to generate the top-view image. In some embodiments, each of the sample bottles b1-bn has the cap, and each cap has a label that corresponds to a sample type (i.e., various trace elements) of the sample contained in the respective sample bottle and a test manner to be used.

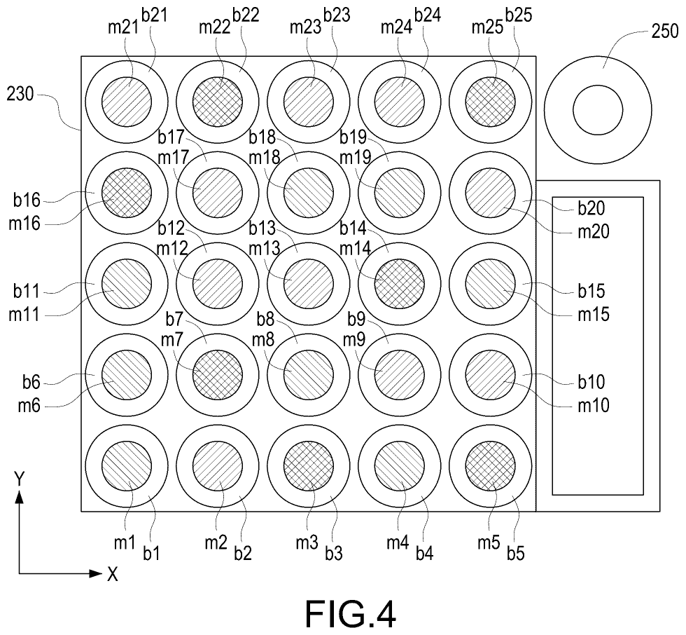

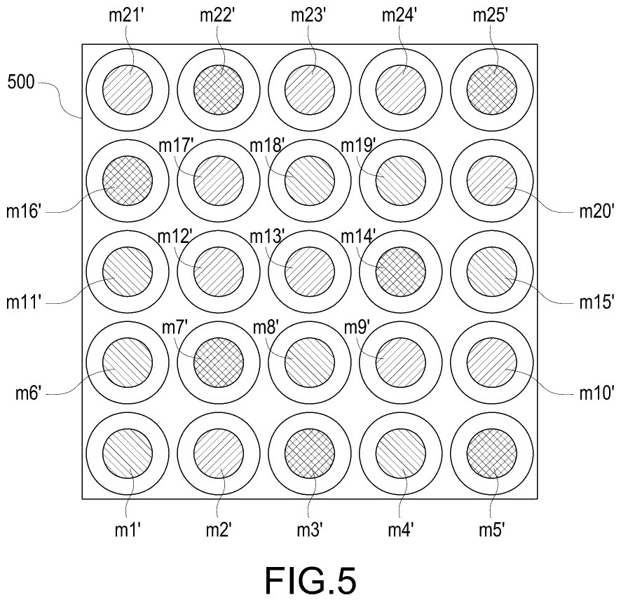

In some embodiments, these labels are multiple color labels, multiple shape labels, multiple barcode labels, multiple text labels, or multiple symbol labels. In some embodiments, different types of the labels correspond to different sample types and different test manners (e.g., atomic absorption spectrometry, electrochemical analysis, or biochemical analysis for the sample in the sample bottle, etc.). In some embodiments, the type of the label is a color type, a shape type, a barcode type, a text type, or a symbol type, etc. The above labels are explained below by a practical example. Reference is made to FIG. 4 and FIG. 5, where FIG. 4 illustrates a schematic diagram of a top-view of the tray 230 in some embodiments of the disclosure, and FIG. 5 illustrates a schematic diagram of an image 500 to be tested in some embodiments of the disclosure. As shown in FIG. 4, the tray 230 carries the sample bottles b1-b25, and the tray 230 is disposed adjacent to the washer 250. The caps of the sample bottles b1-b25 respectively have multiple labels m1-m25. In the disclosure, sizes of the sample bottles b1-b25 and sizes of the caps are the same, and the labels m1-m25 on the caps respectively correspond to the sample types of the samples contained in the sample bottles b1-b25 and/or the test manners to be used for the sample bottles b1-b25, where the same type of the sample and/or the same test manner corresponds to the same label.

In this embodiment, the labels m1-m25 are color labels (i.e., green, red, and blue). The labels m1, m4, m6, m8, m11, m15, m18, and m19 on the cap of the sample bottles b1, b4, b6, m8, m11, m15, m18, and m19 are green labels. The labels m2, m9, m10, m18, m19, b17, b20, b21, b23, and b24 on the cap of the sample bottles b2, b9, b10, m18, m19, m17, m20, m21, m23, and m24 are red labels. The labels m3, m5, m7, m14, m16, m22, and m25 on the cap of the sample bottles b3, b5, b7, b14, m16, m22, and m25 are blue labels. In other words, the sample bottles b1, b4, b6, b8, b11, b15, b18, and b19 contain same type of the sample are required to use the same test manner (e.g., first test manner) for testing the sample, the sample bottles b2, b9, b10, b18, b19, b17, b20, b21, b23, and b24 contain same type of the sample are required to use the same test manner (e.g., second test manner) for testing the sample, and the sample bottles b3, b5, b7, b14, b16, b22, and b25 contain same type of the sample are required to use the same test manner (e.g. third test manner) for testing the sample.

As shown in FIG. 5, the image 500 to be tested is an image generated by the camera circuit 110 through photographing the sample bottles b1-b25 on the tray 230 of FIG. 4 in the top-view. The image 500 to be tested includes multiple label objects m1′-m25′ corresponding to the labels m1-m25 on the caps of the sample bottles b1-b25. The label objects m1′-m25′ have various color types. The color types of the label objects m1′, m4′, m6′, m8′, m11′, m15′, m18′, and m19′ are green. The color types of the label objects m2′, m9′, m10′, m18′, m19′, m17′, m20′, and m21 are red. The color types of the label objects m3′, m5′, m7′, m14′, m16′, m22′, and m25′ are blue.

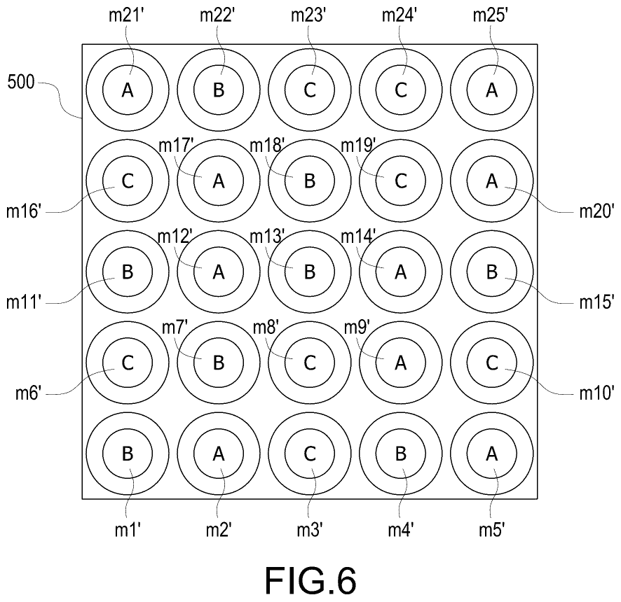

Reference is made to FIG. 6, and FIG. 6 a schematic diagram of the image 600 to be tested in other embodiments of the disclosure. As shown in FIG. 6, in this embodiment, the labels m1-m25 can be the text labels (i.e., “A”, “B”, and “C”). The image 600 to be tested also includes the label objects m1′-m25′. The label objects m1′-m25′ have various text types. The text types of the label objects m1′, m4′, m7′, m11′, m15′, m18′, and m22′ are text “B”. The text types of the label objects m3′, m9′, m12′, m14′, m17′, m20′, m21′, and m25′ are text “A”. The text types of the label objects m3′, m6′, m8′, m10′, m16′, m19′, m23′, and m24′ are text “C”. In this embodiment, the same test manner (e.g., a first manner method) should be used for the multiple sample bottles with the label objects on the caps being the text “B”, the same test manner (e.g., second test manner) should be used for the multiple sample bottles with the label objects on the caps being the text “A”, and the same test manner (e.g. third test manner) should be used for the multiple sample bottles with the label objects on the caps being the text “C”.

Back to FIG. 3, in step S320, the processor 120 performs an object detection process on the top-view image to identify the type (e.g., a color type or a text type) of the label on the cap of each sample bottle and a center point of the label object corresponding to each label in the top-view image, and converts a position of the center point of the label object corresponding to each label in the top-view image into a disposed position of each sample bottle in the chamber. In other words, the processor 120 applies the object detection process to identify the type of the label object and the position of the label object in the top-view image. In some embodiments, the processor 120 performs object detection process on the top-view image to identify a bounding box corresponding to each label object in the top-view image, and converts a position of a center point of the bounding box corresponding to each label object in the top-view image into the disposed position of each sample bottle in the chamber.

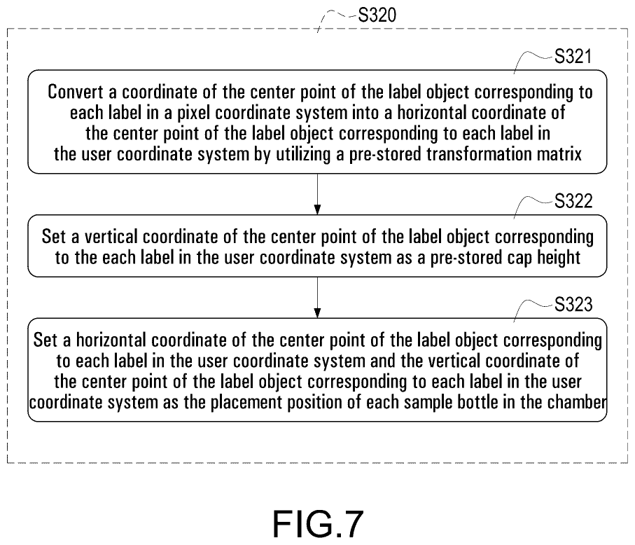

Referring together to FIG. 7, FIG. 7 illustrates a flowchart of detailed steps S321-S323 in step S320 of FIG. 3 in some embodiments of the disclosure. As shown in FIG. 7, in step S321, the processor 120 converts a coordinate of the center point of the label object corresponding to each label in a pixel coordinate system into a horizontal coordinate (i.e., a coordinate in the XY plane) of the center point of the label object corresponding to each label in the user coordinate system by utilizing a pre-stored transformation matrix (e.g., which is pre-calculated by the processor 120).

In step S322, the processor 120 sets the vertical coordinate (i.e., the coordinate in the Z-axis direction) of the center point of the label object corresponding to each label in the user coordinate system as a pre-stored cap height (e.g., a height between a top edge of the cap of each sample bottle and a bottom of the chamber 210 is measured by the user in advance to be set as the cap height). In step S323, the processor 120 sets the horizontal coordinate of the center point of the label object corresponding to each label in the user coordinate system and the vertical coordinate of the center point of the label object corresponding to each label in the user coordinate system as the placement position of each sample bottle in the chamber 210.

In some embodiments, the processor 120 converts a coordinate of the center point of each bounding boxes in the pixel coordinate system into a horizontal coordinate of the center point of each bounding box in the user coordinate system by utilizing the pre-stored transformation matrix, and sets a vertical coordinate of the center point of each bounding box in the user coordinate system as the pre-stored cap height. Next, the processor 120 sets the horizontal coordinate of the center point of each bounding box in the user coordinate system and the vertical coordinates of the center point of each bounding box in the user coordinate system as the placement position of each sample bottle in the chamber 210.

In some embodiments, the control device 100 further includes a memory 130 for storing the placement positions of each sample bottle. In some embodiments, the placement position of each sample bottle includes a horizontal target position and a vertical target position of each sample bottle in the chamber 210. In some embodiments, the horizontal target position and the vertical target position respectively are the above horizontal coordinate of the center point of each bounding box in the user coordinate system and the above vertical coordinate of the center point of each bounding box in the user coordinate system.

In some embodiments, the transformation matrix indicates a correspondence (e.g., a homogeneous matrix) between the pixel coordinate system and the user coordinate system. In some embodiments, the pixel coordinate system is a two-dimensional coordinate system in the image to be tested.

In some embodiments, the object detection process performs object position detection and object categorization on the sample bottle images in the top-view image by utilizing a pre-trained object detection model. In some embodiments, the object detection model is a you only look once (YOLO) algorithm model, a convolutional neural network (CNN) model, or a combination of the above models. For example, the processor 120 pre-trains the YOLO algorithm model by utilizing multiple images having the above labels, training labels (i.e., the types of the above label) in each image, and the bounding boxes of the labels in each image. In this way, the control device 100 identifies the types (e.g., the color type is red) and the positions (i.e., the coordinates of the center points of the bounding boxes of the labels in the pixel coordinate system) of the labels on the caps of the sample bottles b1-bn in the top-view image by utilizing the trained YOLO algorithm model.

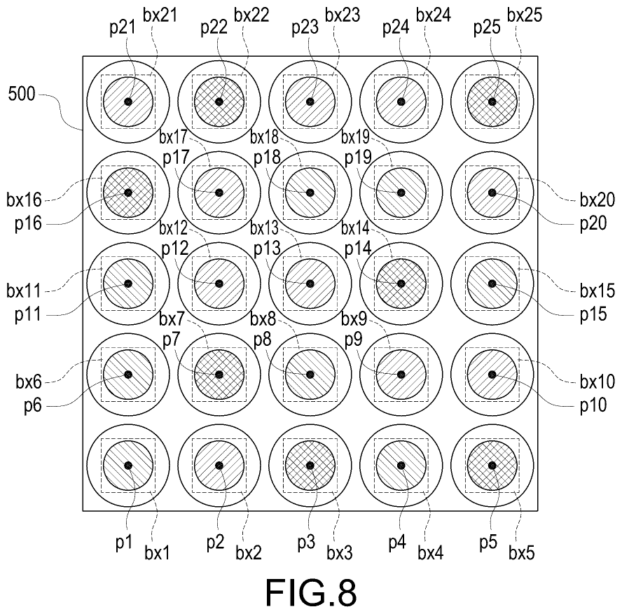

The above coordinate conversion is explained below by a practical example. Reference is made to FIG. 8, and FIG. 8 illustrates a schematic diagram of the multiple bounding boxes bx1-bx25 in some embodiments of the disclosure. As shown in FIGS. 5 and 8, continuing the example of FIG. 5, the processor 120 utilizes the YOLO algorithm model to identify respective type (i.e., the type of label on the cap of each sample bottle) of the label objects m1′-m25′ from the top-view image 500 and the respective bounding boxes bx1˜bx25 (i.e., the bounding box corresponding to each label) of the label objects m1′-m25′, where the color types of the label objects m1′, m4′, m6′, m8′, m11′, m15′, m18′, and m19 are green, the color types of the label objects m2′, m9′, m10′, m18′, m19′, m17′, m20′, m21′, m23′, and m24′ are red, and the color types of the label objects m3′, m5′, m7′, m14′, m16′, m22′, and m25′ are blue.

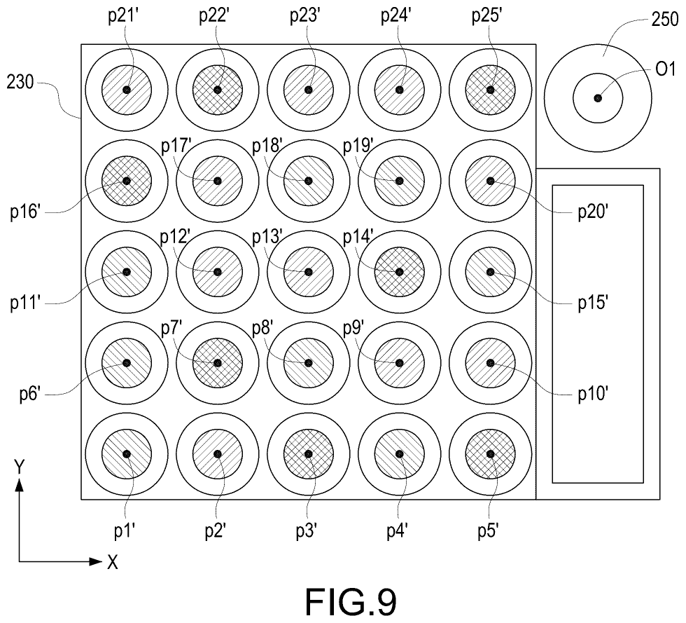

Reference is made to FIG. 9, and FIG. 9 illustrates a schematic diagram of the multiple horizontal coordinates p1′-p25′ in some embodiments of the disclosure. As shown in FIG. 8 and FIG. 9, the processor 120 respectively converts the multiple coordinates p1-p25 of the center points of the bounding boxes bx1-bx25 in the pixel coordinate system into the multiple horizontal coordinates p1′-p25′ of the center points of the bounding boxes bx1-bx25 in the user coordinate system by utilizing the pre-stored homogeneous matrix, and sets all vertical coordinates of the center points of the bounding boxes bx1-bx25 in the user coordinate system as the pre-stored cap height. If the multiple sample bottles b1-b25 have the same size, the multiple vertical coordinates are equal. Next, the processor 120 respectively sets the horizontal coordinates p1′-p25′ of the center points of the bounding boxes bx1-bx25 in the user coordinate system and the vertical coordinates of the center points of the bounding boxes bx1-bx25 in the user coordinate system as the placement positions of the sample bottles in the chamber 210.

In some embodiments, the processor 120 first sets a center point O1 of a bottle neck of the washer 250 as a starting position of the detector bar 2211 on the lift arm 221 in the actuator 220. By controlling the camera circuit 110 to capture the top-view image when the lift arm 221 and the detector bar 2211 are on the starting position, the problem that the sample bottles may be difficult to be identified by the processor 120 because of the detector bar 2211 appearing in the top-view image and blocking some of the sample bottles can be avoided.

Back to FIG. 3, in step S330, the processor 120 divides the multiple sample bottles b1-b25 into multiple groups based on respective type of the multiple labels, and sorts the multiple groups to generate a sampling order, where the multiple groups respectively correspond to different sample types (e.g., a first sample, a second sample, a third sample, etc.) and different test manners (e.g., performing the atomic absorption spectrometry (AAS) for the first sample, the electrochemical spectrometry for the second sample, and the biochemical analysis for the third sample, etc.). In some embodiments, the processor 120 is set to sample the sample contained in the sample bottles in the same group (the sample bottles in the same group should be containing the same sample type of sample) in the same time sequence for the same test manner (e.g., sampling the sample in one or more sample bottles of a first group for the atomic absorption spectrometry in a first time sequence, sampling the sample in one or more sample bottles of a second group for the electrochemical analysis in a second time sequence after the first time sequence, and sampling the sample in one or more sample bottles in a third group for the biochemical analysis in a third time sequence after the second time sequence).

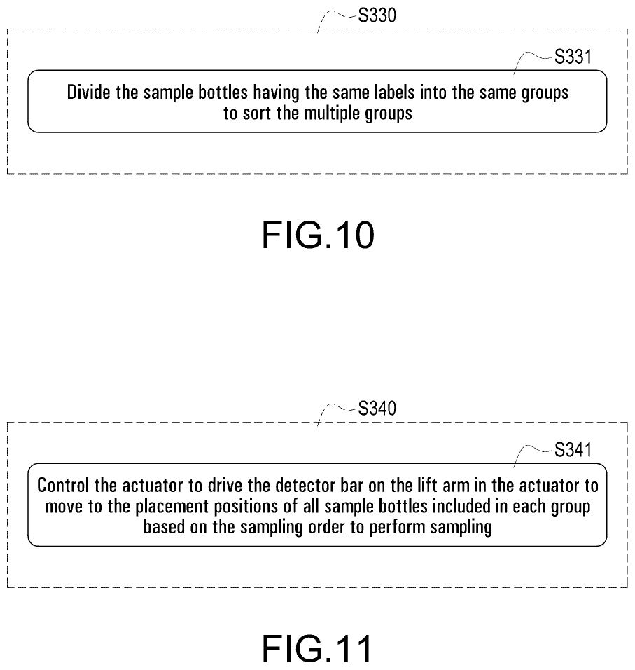

Reference is made to FIG. 10, and FIG. 10 illustrates a flowchart of a detailed step S331 in step S330 of FIG. 3 in some embodiments of the disclosure. As shown in FIG. 10, in step S331, the processor 120 sorts the sample bottles having the labels of same type (e.g., the labels having the same color or the labels having the same text) into the same group to sort the multiple groups. In some embodiments, the processor 120 randomly samples the multiple sample bottles in the same group or samples the sample bottles in the same group in a particular order (e.g., the sample bottle closer to an origin of the user coordinate system in FIG. 2 is sampled first). In some embodiments, the sampling order indicates the sampling priority of each group.

For example, as shown in FIG. 4 and FIG. 5, the processor 120 has identified that the color types of the label objects m1′, m4′, m6′, m8′, m11′, m15′, m18′, and m19′ are green, the color types of the label objects m2′, m9′, m10′, m18′, m19′, m17′, m20′, m21′, m23′, and m24′ are red, and the color types of the label objects m3′, m5′, m7′, m14′, m16′, m22′, and m25′ are blue. Therefore, the processor 120 divides the sample bottles b1, b4, b6, b8, b11, b15, b18, and b19 into the first group, divides the sample bottles b2, b9, b10, b18, b19, b17, b20, b21, b23, b24 into the second group, and divides the sample bottles b3, b5, b7, b14, b16, b22, and b25 into the third group. Next, the processor 120 sequentially arranges the first group to the third group to generate the sampling order (i.e., an order in which the first group to the third group are sampled sequentially), where the sampling order indicates the sampling priority of each of the first group to the third group.

Back to FIG. 3, in step S340, the processor 120 controls the actuator 220 to drive the detector bar 2211 on the lift arm 221 in the actuator 220 to sequentially collect the samples in the sample bottles included in each group based on the sampling order and the multiple placement positions. Reference is made to FIG. 11, and FIG. 11 illustrates a flowchart of a detailed step S341 in step S340 of FIG. 3 in some embodiments of the disclosure. As shown in FIG. 11, in step S341, the processor 120 controls the actuator 220 to drive the detector bar 2211 on the lift arm 221 in the actuator 220 to move to the placement positions of all sample bottles included in each group based on the sampling order to perform sampling.

For example, as shown in FIG. 4, continuing the previous example, assuming that the processor 120 has sequentially arranged the first group to the third group and generated the sampling order, in the first time sequence, the processor 120 controls the actuator 220 to drive the detector bar 2211 on the lift arm 221 in the actuator 220 from the starting position (i.e., a center point of the bottle neck of the above washer 250) to sequentially move to the placement positions of the multiple sample bottles b1, b4, b6, b8, b11, b15, b18, and b19 in the first group, so that sequentially collects the samples in these sample bottles b1, b4, b6, b8, b11, b15, b18, and b19 and performs the test manner (e.g., the atomic absorption spectrometry) corresponding to the first group.

Next, in the second time sequence after the first time sequence, the processor 120 controls the actuator 220 to drive the detector bar 2211 on the lift arm 221 of the actuator 220 from the placement position of the last sampled sample bottle (e.g., the sample bottle b19) to sequentially move to the placement positions of the multiple sample bottles b2, b9, b10, b18, b19, b17, b20, b21, b23, and b24 in the second group, so that sequentially collects the samples in these sample bottles b2, b9, b10, b18, b19, b17, b20, b21, b23, and b24 and performs the test manner (e.g., the electrochemical analysis) corresponding to the second group. Next, in the third time sequence after the second time sequence, the processor 120 controls the actuator 220 to drive the detector bar 2211 on the lift arm 221 of the actuator 220 from the placement position of the last sampled sample bottle (e.g., the sample bottle b24) to sequentially move to the placement positions of the multiple sample bottles b3, b5, b7, b14, b16, b22, b25 in the third group, so that sequentially collects the samples in these sample bottles b3, b5, b7, b14, b16, b22, and b25 and performs the test manner (e.g., the biochemical analysis) corresponding to the third group.

In other words, sample bottles for the same testing manner are sampled in the same time sequence. In this way, the processor 120 samples and tests a large number of the sample bottle that are performed in the same test manner once. Therefore, the processor 120 does not need to frequently switch between different test manners during the sampling and detection process, and thus the sampling and detection efficiency of all sample bottles b1-bn is improved.

In some embodiments, the processor 120 controls the actuator 220 to drive the gripper 223 to clamp the cap of each sample bottle before sampling the sample bottles, and controls the actuator 220 to drive the gripper 223 horizontally rotating to unscrew the cap. Next, the processor 120 controls the actuator 220 to drive the gripper 223 to vertically rotate to a position perpendicular to the tray 230 based on the pivot 2231 to remove the cap of each sample bottle. After completing the sampling operation for each sample bottle by the detector bar 2211, the processor 120 then controls the actuator 220 to drive the gripper 223 to vertically rotate to a position parallel to the tray 230 based on the pivot 2231 to place the cap back on each sample bottle. Next, the processor 120 controls the actuator 220 to drive the gripper 223 to horizontally rotate to screw the cap.

An embodiment is further presented below to explain how the processor 120 controls the actuator 220 to drive the detector bar 2211 on the lift arm 221 in the actuator 220 to collect the sample in the sample bottle. For the purpose of explaining the control of sampling, the following paragraphs take the collection of the sample in the sample bottle b5 of FIG. 5 as an example.

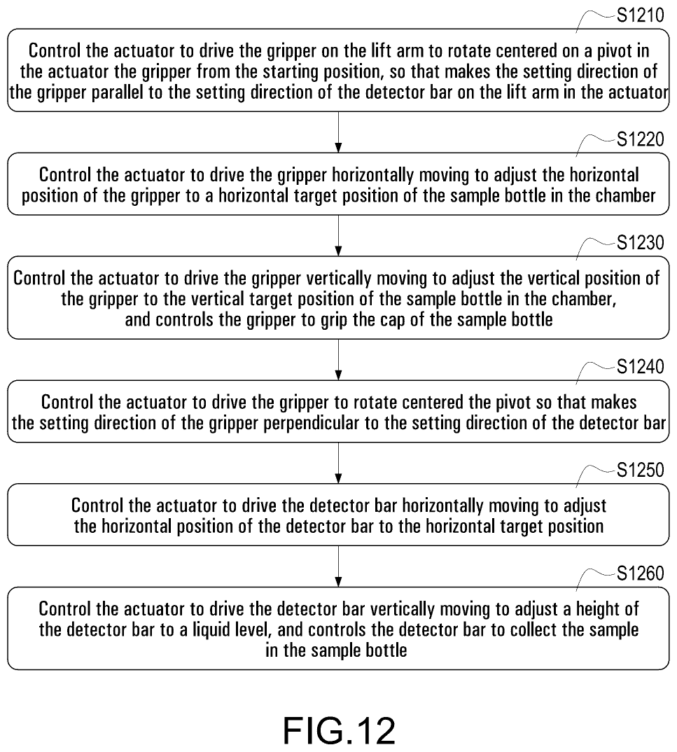

Reference is made to FIG. 12, FIG. 12 illustrates a flowchart of a sampling control method in some embodiments of the disclosure, which is suitable to the control device 100 shown in FIG. 1 and the detection device 200 of FIG. 2. As shown in FIG. 12, the sampling control method includes steps S1210-S1260. First, in step S1210, the processor 120 controls the actuator 220 to drive the gripper 223 on the lift arm 221 to rotate centered on the pivot 2231 in the actuator 220 from the starting position, so that makes the setting direction of the gripper 223 to be parallel to the setting direction of the detector bar 2211 on the lift arm 221 in the actuator 220. In some embodiments, the processor 120 controls the pivot 2231 in the actuator 220 to rotate to drive the gripper 223 until the setting direction of the gripper 223 is parallel to the setting direction of the detector bar 2211 on the lift arm 221.

It should be noted that the memory 130 has pre-stored a conversion relationship between the user coordinate system and the position of the gripper 223. Therefore, the processor 120 continuously obtains the coordinates of the gripper 223 in the user coordinate system based on this conversion relationship during these operations to obtain the position and the setting direction of the gripper 223. Similarly, the memory 130 has pre-stored a conversion relationship between the user coordinate system and the position of the detector bar 2211. Therefore, the processor 120 also continuously obtains the coordinates of the detector bar 2211 on the user coordinate system based on this conversion relationship during these operations to obtain the position and the setting direction of the detector bar 2211.

In addition, the position of the gripper 223 refers to a position of an end center point of the gripper 223 (i.e., a geometric center of the end of multiple claws of the gripper 223), and the position of the detector bar 2211 is an end center point of an end of the detector bar 2211 (i.e., a sampling point of the end of the detector bar 2211).

In some embodiments, when the setting direction of the gripper 223 is parallel to the setting direction of the detector bar 2211 on the lift arm 221, a horizontal position of the gripper 223 is located at a horizontal position of the center point O1 of the bottle neck of the washer 250.

In detail, since the setting direction of the detector bar 2211 is perpendicular to the XY plane in the user coordinate system, the processor 120 controls the actuator 220 to drive the gripper 223 on the lift arm 221 to rotate from the starting position of the gripper 223 to another position, where the other position is the position of the gripper 223 when the setting direction of the gripper 223 is perpendicular to the XY plane in the user coordinate system. At this time, the horizontal position of the gripper 223 is exactly at the horizontal position of the center point O1 of the bottle neck of the washer 250.

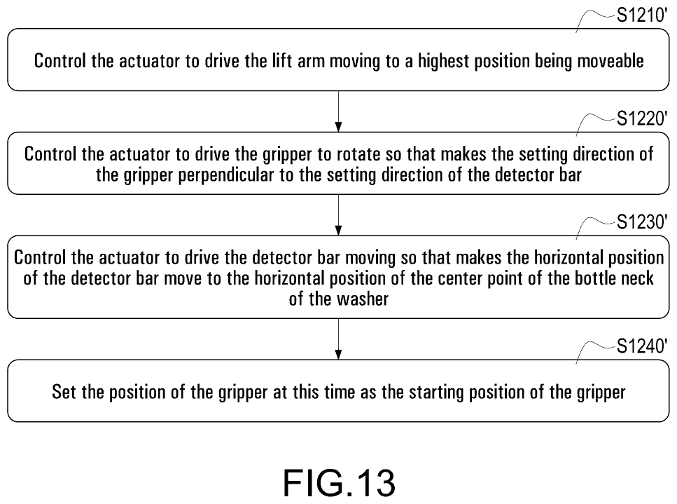

Reference is made to FIG. 13, and FIG. 13 illustrates a schematic diagram of steps S1210′-1240′ executed before step S1210 of FIG. 12 in some embodiments of the disclosure. As shown in FIG. 13, in step S1210′, the processor 120 controls the actuator 220 to drive the lift arm 221 moving to a highest position of the actuator 220. In step S1220′, the processor 120 controls the actuator 220 to drive the gripper 223 to rotate to make the setting direction of the gripper 223 perpendicular to the setting direction of the detector bar 2211. In step S1230′, the processor 120 controls the actuator 220 to drive the detector bar 2211 to move the horizontal position of the detector bar 2211 to the horizontal position of the center point O1 of the bottle neck of the washer 250. In step S1240′, the processor 120 sets the position of the gripper 223 at this time as the starting position of the gripper 223. After the processor 120 has finished setting the starting position of the gripper 223, the processor 120 starts to execute step S1210. In other words, the processor 120 starts executing the steps shown in FIG. 12 after setting the starting position of the gripper 223 and moving the gripper 223 to the starting position.

In some embodiments, when the setting direction of the gripper 223 is parallel to the setting direction of the detector bar 2211 on the lift arm 221, a vertical position of the gripper 223 is at the highest position that the gripper 223 can be move (because the lift arm 221 has been moved to the highest position, so a height of the gripper 223 has been adjusted to a maximum height).

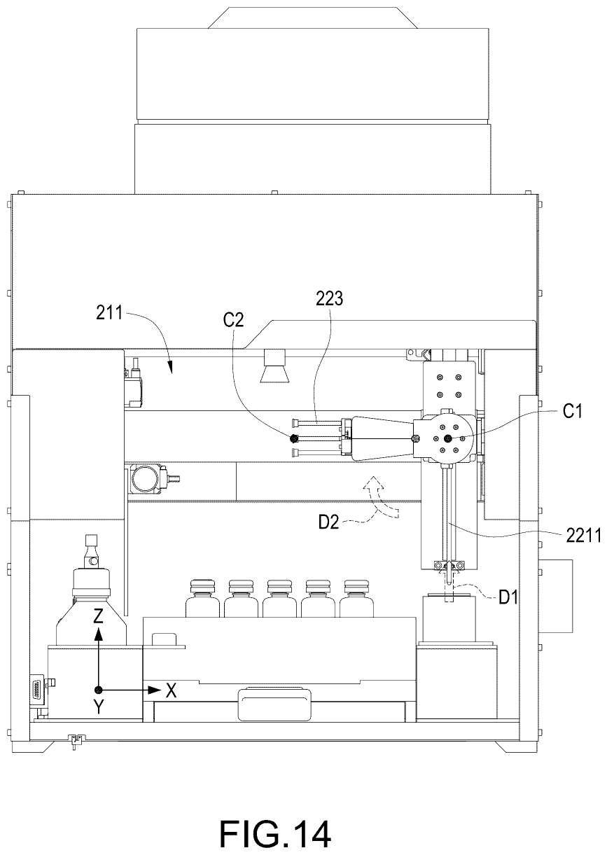

The starting position of the gripper 223 and rotation of the gripper 223 are explained below by a practical example. Reference is made to FIG. 14, and FIG. 14 illustrates a schematic diagram of the starting position of the gripper 223 in some embodiments of the disclosure. As shown in FIG. 14, FIG. 14 is a front-view of the space 211 in the box 210.

In the space 211 in the chamber 210, the processor 120 first controls the actuator 220 to drive the lift arm 221 to move to the highest position along a moving direction D1. Next, the processor 120 controls the actuator 220 to drive the gripper 223 to rotate clockwise (i.e., rotating in a rotation direction D2) based on a rotation center C1 of the pivot 2231 until the setting direction of the gripper 223 is perpendicular to the setting direction of the detector bar 2211 (i.e., perpendicular to the XY plane in the user coordinate system). At this time, the processor 120 makes the position of an end center point C2 of the gripper 223 as the starting position of the gripper 223.

It should be noted that such a manner by controlling the actuator 220 to drive the gripper 223 to the starting position of the gripper 223 (i.e., resetting to zero) avoids the problem of positional deviation caused by previous fine-tuning control (i.e., manipulation before returning to the starting position) for the actuator 220.

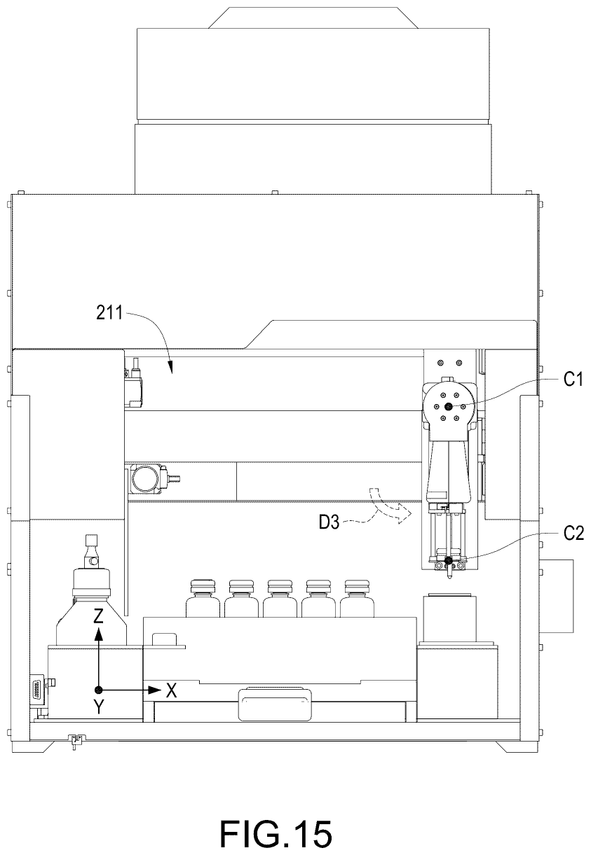

Reference is made to FIG. 15, and FIG. 15 illustrates a schematic diagram of the gripper 223 starting to rotate in some embodiments of the disclosure. As shown in FIG. 15, continuing the example of FIG. 14, the processor 120 controls the actuator 220 to drive the gripper 223 on the lift arm 221 to rotate counterclockwise (i.e., in a rotation direction D3) based on the rotation center C1 of the pivot 2231, so that makes the setting direction of the gripper 223 parallel to the setting direction of the detector bar 2211 (i.e., parallel to the Z-axis direction in the user coordinate system).

In other words, the processor 120 controls the actuator 220 to drive the gripper 223 to rotate from the starting position of the gripper 223 as shown in FIG. 14 to the position of the end center point C2 of the gripper 223 as shown in FIG. 15 (i.e., moving the gripper 223 from a coordinate of the starting position of FIG. 14 in the user coordinate system to a coordinate of the end center point C2 of the gripper 223 of FIG. 15 in the user coordinate system). At this time, a horizontal coordinate of the end center point C2 of the gripper 223 in the user coordinate system is a horizontal coordinate of the center point O1 of the bottle neck of the washer 250 in the user coordinate system.

Back to FIG. 12, in step S1220, the processor 120 controls the actuator 220 to drive the gripper 223 horizontally moving to adjust the horizontal position of the gripper 223 to a horizontal target position of the sample bottle b5 in the chamber 210. In some embodiments, the processor 120 controls the slide 222 in the actuator 220 to drive the gripper 223 to horizontally move until the horizontal position of the gripper 223 is adjusted to the horizontal target position of the sample bottle b5 in the chamber 210.

In some embodiments, the processor 120 controls the actuator 220 to drive the gripper 223 to horizontally move in a horizontal direction (i.e., in the X and Y axis directions) in the user coordinate system to the horizontal target coordinate, where the horizontal target coordinates indicate a horizontal target position of the sample bottle b5 in the chamber 210. In some embodiments, the processor 120 controls the actuator 220 to drive the gripper 223 horizontally moving a minimum straight-line distance so that makes the gripper 223 to move to the horizontal target coordinate. In other embodiments, the processor 120 also first controls the actuator 220 to drive the gripper 223 to move to the X-component coordinate in the horizontal target coordinate, and then controls the actuator 220 to drive the gripper 223 to move to the Y-component coordinate in the horizontal target coordinate.

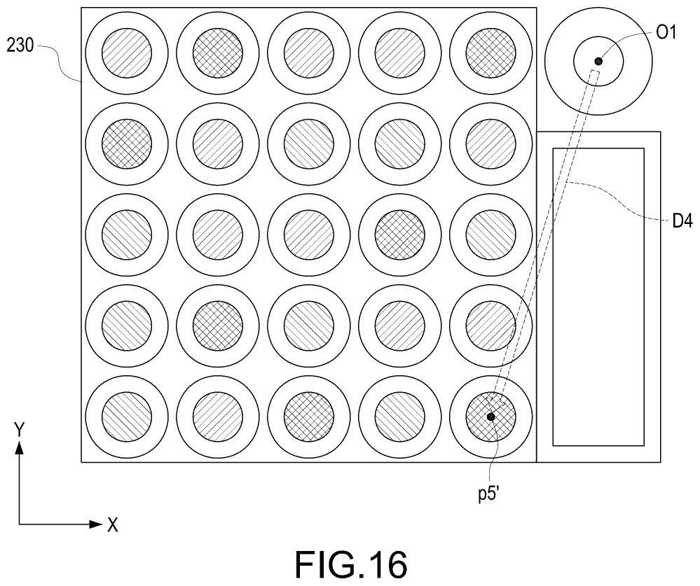

The horizontal movement of the gripper 223 is explained below by a practical example. Reference is made to FIG. 16, and FIG. 16 illustrates a schematic diagram of the horizontal movement of the gripper 223 in some embodiments of the disclosure. As shown in FIG. 16, continuing the example of FIG. 15, the processor 120 controls the actuator 220 to drive the gripper 223 to move the horizontal position of the end center point of the gripper 223 from the horizontal coordinate of the center point O1 of the bottle neck of the washer 250 to the horizontal coordinate p5′ of the sample bottle b5 in a moving direction D4, where a moving path of the gripper 223 is a path having a minimum straight-line distance.

At this time, the end center point of the gripper 223 has been moved to the position above the center point of the cap of the sample bottle b5 (because the lift arm 221 has been moved to the highest position that can be moved by the above resetting). In other words, if the tray 230 is viewed in a top-view, the end center point of the gripper 223 overlaps the center point of the cap of the sample bottle b5.

In step S1230, the processor 120 controls the actuator 220 to drive the gripper 223 vertically moving to adjust the vertical position of the gripper 223 to the vertical target position of the sample bottle b5 in the chamber 210, and controls the gripper 223 to grip the cap of the sample bottle b5.

In some embodiments, the processor 120 controls the actuator 220 to drive the gripper 223 moving to the vertical target coordinate along the vertical direction (i.e., the Z-axis direction) in the user coordinate system, where the vertical target coordinate indicates the vertical target position of the sample bottle b5 in the chamber 210. In some embodiments, the processor 120 controls the lift arm 221 in the actuator 220 to move along the-Z-axis direction in the user coordinate system until the vertical coordinate of the gripper 223 is adjusted to the vertical target coordinate. In this way, the processor 120 controls the gripper 223 to clamp the cap of the sample bottle b5. At this time, both the vertical coordinates of the gripper 223 and the detector bar 2211 are adjusted to the vertical target coordinate.

In some embodiments, when the gripper 223 clamps the cap of the sample bottle b5, the processor 120 controls the actuator 220 to drive the gripper 223 to horizontally rotate (i.e., rotating centered the Z-axis direction) to unscrew the cap. Next, the processor 120 controls the actuator 220 to drive the lift arm 221 moving to the highest position that the lift arm 221 can move in the vertical direction in the user coordinate system to separate the cap from the sample bottle b5. In detail, when the processor 120 determines that the vertical coordinate of the gripper 223 is adjusted to the vertical target coordinate, the processor 120 controls the gripper 223 to clamp the cap of the sample bottle b5. Next, the processor 120 controls the gripper 223 to horizontally rotate to unscrew the cap, and then controls the gripper 223 to move along the Z-axis direction in the user coordinate system until the gripper 223 moves to the highest position that the lift arm 221 can move. In this way, the processor 120 controls the actuator 220 to drive the detector bar 2211 to start moving towards the position of the center point of the bottle neck of the sample bottle b5.

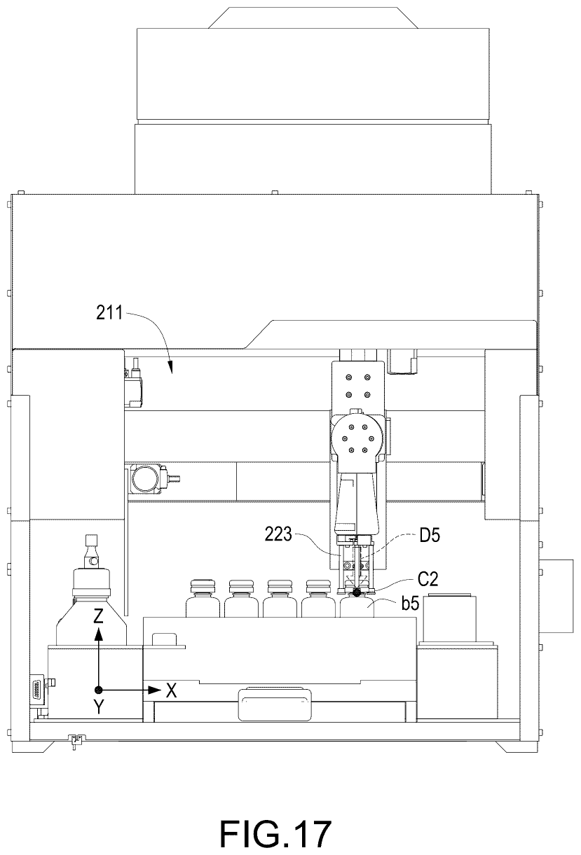

The gripping of the cap of the sample bottle b5 by the gripper 223 is explained below by a practical example. Reference is made to FIG. 17, and FIG. 17 illustrates a schematic diagram of the gripper 223 gripping the cap of the sample bottle b5 in some embodiments. As shown in FIG. 17, continuing the example of FIG. 16, the processor 120 controls the actuator 220 to drive the gripper 223 to move the end center point C2 of the gripper 223 from the vertical coordinate of the gripper 223 in the user coordinate system to the above vertical target coordinate along a moving direction D5. In other words, the end center point C2 of the gripper 223 has been moved to the position of the center point of the cap of the sample bottle b5. In this way, the processor 120 controls the gripper 223 to clamp the cap of the sample bottle b5.

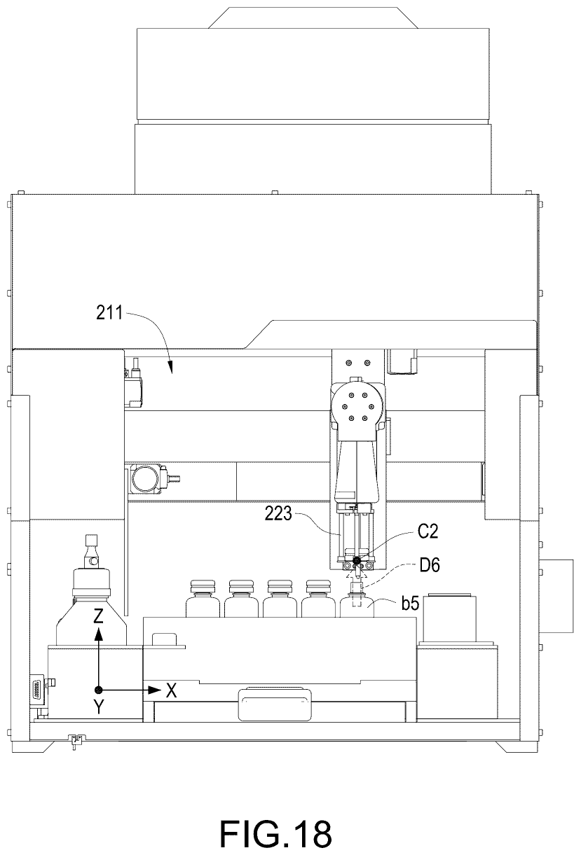

Reference is made to FIG. 18, and FIG. 18 illustrates a schematic diagram of the gripper 223 opening the cap of the sample bottle b5 in some embodiments of the disclosure. As shown in FIG. 18, continuing the example of FIG. 17, when the gripper 223 clamps the cap of the sample bottle b5, the processor 120 controls the actuator 220 to drive the lift arm 221 moving along the Z-axis direction in the user coordinate system so that makes the lift arm 221 to move to the highest position which the lift arm 221 can be moved. At this time, the end center point C2 of the gripper 223 is moved in a moving direction D6 to remove the cap from the sample bottle b5.

Back to FIG. 12, in step S1240, the processor 120 controls the actuator 220 to drive the gripper 223 to rotate centered the pivot 2231 so that makes the setting direction of the gripper 223 to be perpendicular to the setting direction of the detector bar 2211. In other words, the processor 120 makes the gripper 223 to rotate so that makes the setting direction of the gripper 223 to be perpendicular to the vertical direction in the user coordinate system (un this time, the setting direction of the detector bar 2211 is parallel to the vertical direction in the user coordinate system). In some embodiments, the processor 120 controls the pivot 2231 in the actuator 220 to rotate to drive the gripper 223 until the setting direction of the gripper 223 is perpendicular to the Z-axis direction in the user coordinate system. In some embodiments, the memory 130 further pre-stores a horizontal position (i.e., a horizontal coordinate in the user's coordinate system) of each of a first interior wall and a second interior wall of the chamber 210.

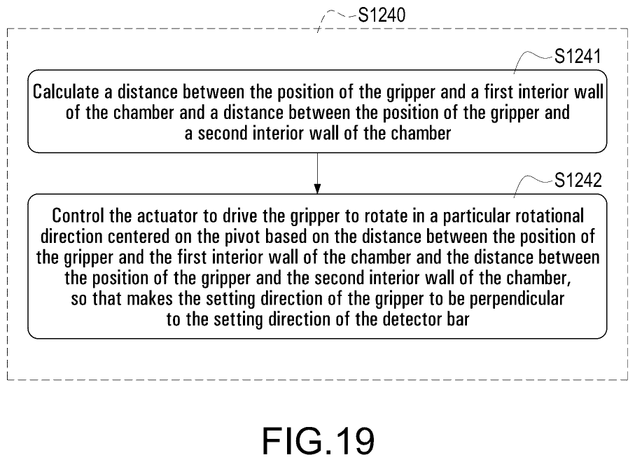

Reference is made to FIG. 19, and FIG. 19 illustrates a flowchart of detailed steps S1241-S1242 of step S1240 of FIG. 12 in some embodiments of the disclosure. As shown in FIG. 19, in step S1241, the processor 120 calculates a distance between the position of the gripper 223 and the first interior wall of the chamber 210 and a distance between the position of the gripper 223 and the second interior wall of the chamber 210. In step S1242, the processor 120 controls the actuator 220 to drive the gripper 223 to rotate in a particular rotational direction centered on the pivot 2231 based on the distance between the position of the gripper 223 and the first interior wall of the chamber 210 and the distance between the position of the gripper 223 and the second interior wall of the chamber 210, so that makes the setting direction of the gripper 223 to be perpendicular to the setting direction of the detector bar 2211. In this embodiment, the processor 120 decides a specific rotation direction based on calculating the distance between the position of the gripper 223 and the first interior wall of the chamber 210 and the distance between the position of the gripper 223 and the second interior wall of the chamber 210, which ensures that the gripper 223 neither collides with the first interior wall nor collides with the second interior wall, so as to prevent the gripper 223 from causing damage when rotating.

In some embodiments, the first interior wall and the second interior wall respectively are a right interior wall (i.e., the interior wall closest to the washer 250 of FIG. 2) and a left interior wall (i.e., the interior wall farthest to the washer 250 of FIG. 2). In some embodiments, the processor 120 determines whether the distance between the position of the gripper 223 and the right interior wall of the chamber 210 is greater than the distance between the position of the gripper 223 and the left interior wall of the chamber 210. Next, when the processor 120 determines that the distance between the position of the gripper 223 and the right interior wall of the chamber 210 is greater than the distance between the position of the gripper 223 and the left interior wall of the chamber 210, the processor 120 sets the rotation direction as a direction of rotating towards the left interior wall of the chamber 210 (i.e., rotating 90 degrees counterclockwise along the Y-axis direction). On the contrary, when the processor 120 determines that the distance between the position of the gripper 223 and the right interior wall of the chamber 210 is not greater than the distance between the position of the gripper 223 and the left interior wall of the chamber 210, the processor 120 sets the rotation direction as a direction of rotating towards the right interior wall of the chamber 210 (i.e., rotating 90 degrees clockwise along the Y-axis direction). In this way, the gripper 223 is prevented from colliding with the interior walls of the chamber 210 when rotating.

In other embodiments, the first interior wall and the second interior wall respectively are the front interior wall (i.e., the interior wall closest to first row of the sample bottles b1-b5 of FIG. 2) and the rear interior wall (i.e., the interior wall farthest from the first row of sample bottles b1-b5 of FIG. 2). In other embodiments, the processor 120 determines whether the distance between the position of the gripper 223 and the front interior wall of the chamber 210 is greater than the distance between the position of the gripper 223 and the rear interior wall of the chamber 210. Next, when the processor 120 determines that the distance between the position of the gripper 223 and the front interior wall of the chamber 210 is greater than the distance between the position of the gripper 223 and the rear interior wall of the chamber 210, the processor 120 sets the rotation direction as a direction of rotating towards the front interior wall of the chamber 210 (i.e., rotating 90 degrees clockwise along the X-axis direction). On the contrary, when the processor 120 determines that the distance between the position of the gripper 223 and the front interior wall of the chamber 210 is not greater than the distance between the position of the gripper 223 and the rear interior wall of the chamber 210, the processor 120 sets the rotation direction as a direction of rotating towards the rear interior wall of the chamber 210 (i.e., rotating 90 degrees counterclockwise along the X-axis direction). In this way, the gripper 223 is prevented from colliding with the interior walls of the chamber 210 when rotating.

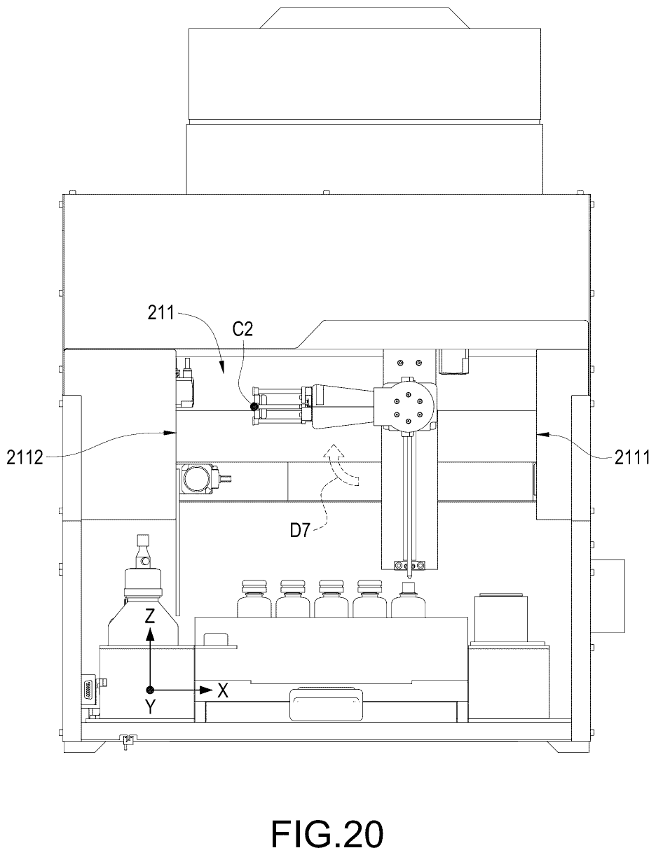

The rotation of the gripper 223 after clamping the cap is explained below by a practical example. Referring to FIG. 20 together, FIG. 20 illustrates a schematic diagram of the gripper 223 rotating after clamping the cap in some embodiments of the disclosure. As shown in FIG. 20, continuing the example of FIG. 18, the processor 120 first calculates the distance between the position of the gripper 223 and the first interior wall 2111 of the chamber 210 and the distance between the position of the gripper 223 and the second interior wall 2112 of the chamber 210. Next, the processor 120 determines whether the distance between the position of the gripper 223 and the first interior wall 2111 of the chamber 210 is greater than the distance between the position of the gripper 223 and the second interior wall 2112 of the chamber 210.

In the example of FIG. 20, the processor 120 determines that the distance between the position of the gripper 223 and the first interior wall 2111 of the chamber 210 is not greater than the distance between the position of the gripper 223 and the second interior wall 2112 of the chamber 210. Therefore, the processor 120 sets the rotation direction as a rotation direction D7. In this way, the processor 120 controls the actuator 220 to drive the end center point C2 of the gripper 223 to rotate 90 degrees clockwise centered the rotation center C1 of the pivot 2231 along the rotation direction D7.

Back to FIG. 12, in step S1250, the processor 120 controls the actuator 220 to drive the detector bar 2211 horizontally moving to adjust the horizontal position of the detector bar 2211 to the horizontal target position. In some embodiments, since the gripper 223 and the detector bar 2211 are jointly disposed on the lift arm 221, a horizontal distance exists between the horizontal position of the gripper 223 and the horizontal position of the detector bar 2211 in the user coordinate system when the setting direction of the gripper 223 is parallel to the setting direction of the detector bar 2211. In some embodiments, the processor 120 controls the actuator 220 to drive the detector bar 2211 to move for the horizontal distance along the horizontal direction in the user coordinate system to adjust the horizontal position of the detector bar 2211 to the horizontal target position. In some embodiments, the horizontal distance in the horizontal direction in the user coordinate system is a distance along the Y-axis direction in the user coordinate system. In some embodiments, the processor 120 controls the slide 222 in the actuator 220 to drive the detector bar 2211 to move for the above horizontal distance along the-Y axis direction in the user coordinate system.

In other words, because a distance along the Y-axis direction in the user coordinate system between the horizontal position of the gripper 223 and the horizontal position of the detector bar 2211 exactly exists when the setting direction of the gripper 223 is parallel to the setting direction of the detector bar 2211, as long as the processor 120 controls the slide 222 in the actuator 220 to drive the detector bar 2211 to move for this distance along the Y-axis direction in the user coordinate system, the end center point of the detector bar 2211 just moves to the center point of the bottle neck of the sample bottle b5.

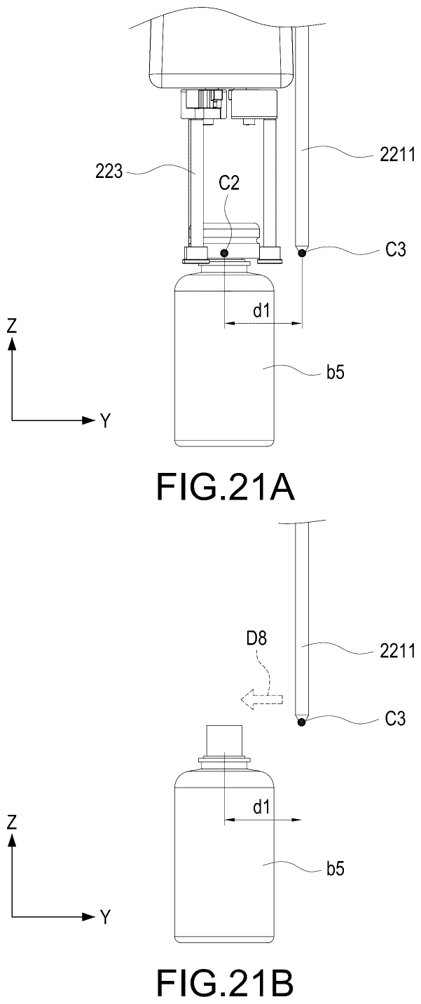

The horizontal distance and the adjustment of the horizontal position of the detector bar are explained below by a practical example 2211. Reference is made to FIG. 21A, and FIG. 21A illustrates the schematic diagram of the horizontal distance in some embodiments of the disclosure. As shown in FIG. 21A, FIG. 21A is a side-view of the gripper 223 and the detector bar 2211. Continuing the example of FIG. 18, the setting direction of the gripper 223 is parallel to the setting direction of the detector bar 2211, and a distance D1 along the Y-axis direction in the user coordinate system exists between the horizontal position of the end center point C2 of the gripper 223 and the horizontal position of an end center point C3 of the detector bar 2211.

Because the distance D1 (i.e., the above horizontal distance) along the Y-axis direction in the user coordinate system exists between the horizontal position of the end center point C2 of the gripper 223 and the horizontal position of the end center point C3 of the detector bar 2211, the distance D1 along the Y-axis direction in the user coordinate system also exists between the horizontal position of the end center point C3 of the detector bar 2211 and the above horizontal target position (because the end center point C2 of the gripper 223 is just located at the position of the cap of the sample bottle b5).

Reference is made to FIG. 21B, and FIG. 21B illustrates a schematic diagram of the adjustment of the horizontal position of the detector bar 2211 in some embodiments of the disclosure. As shown in FIG. 21B, FIG. 21B is a side-view of the detector bar 2211. Continuing the example of FIG. 19, the distance D1 along the Y-axis direction in the user coordinate system exists between the horizontal position of the end center point C3 of the detector bar 2211 and the above horizontal target position in this time.

Because the distance D1 along the Y-axis direction in the user coordinate system exists between the horizontal position of the end center point C3 of the detector bar 2211 and the above horizontal target position, the processor 120 controls the slide 222 to driver the detector bar 2211 in the actuator 220 horizontally moving along a moving direction D8 along the Y-axis direction in the user coordinate system, so that makes the horizontal position of the end center point C3 of the detector bar 2211 to move to the horizontal target position. In this way, the end center point C3 of the detector bar 2211 has moved to the position of the center point of the bottle neck of the sample bottle b5, so that starts sampling the sample in the sample bottle b5.

Back to FIG. 12, in step S1260, the processor 120 controls the actuator 220 to drive the detector bar 2211 vertically moving to adjust a height of the detector bar 2211 to a liquid level, and controls the detector bar 2211 to collect the sample in the sample bottle b5. In some embodiments, the processor 120 controls the pivot 2231 in the actuator 220 to drive the detector bar 2211 along the-Z axis direction in the user coordinate system until the height of the detector bar 2211 is adjusted to the liquid level.

In some embodiments, the memory 130 further pre-stores the liquid level of the sample in the sample bottle b5. In some embodiments, the liquid level is pre-measured by a user to be stored in the memory 130, where the liquid level indicates a height of the liquid surface of the sample in the sample bottle b5 along the Z-axis direction in the user coordinate system. At this time, the processor 120 first switches to a corresponding detection mode and controls the detector bar 2211 to collect the sample in the sample bottle b5.

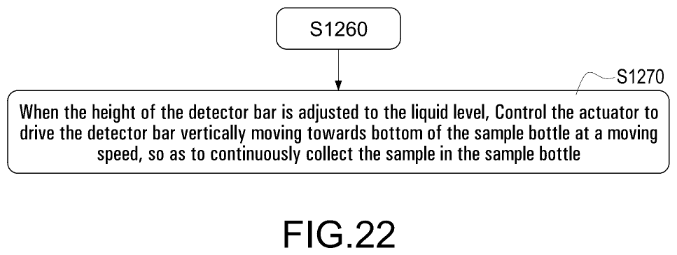

Reference is made to FIG. 22, and FIG. 22 illustrates a flowchart of step S1270 executed after step S1260 of FIG. 2 in some embodiments of the disclosure. As shown in FIG. 22, in step S1270, when the height of the detector bar 2211 is adjusted to the liquid level, the processor 120 controls the actuator 220 to drive the detector bar 2211 vertically moving towards bottom of the sample bottle b5 at a moving speed, so as to continuously collect the sample in the sample bottle b5. In other words, after executing step S1260, the detector bar 2211 vertically moves towards the bottom of the sample bottle b5 at the moving speed until the sample in the sample bottle b5 is completely collected. In some embodiments, the processor 120 controls the pivot 2231 in the actuator 220 to drive the detector bar 2211 to continue moving at the moving speed along the-Z axis in the user coordinate system. In detail, because the liquid level of the sample in the sample bottle b5 decreases as sampling time increases, the user pre-sets the moving speed towards the bottom of the sample bottle b5 by the processor 120 so that the height of the detector bar 2211 decreases as the liquid level decreases.

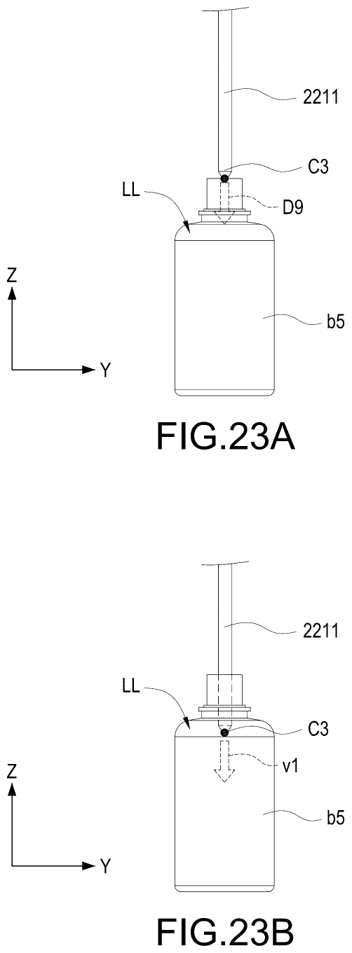

Reference is made to FIG. 23A, and FIG. 23A illustrates a schematic diagram of the vertical movement of the detector bar 2211 in some embodiments of the disclosure. As shown in FIG. 23A, FIG. 23A also shows the side-view of the detector bar 2211. The processor 120 controls the pivot 2231 in the actuator 220 to drive the detector bar 2211 along the Z-axis direction of the user coordinate system in a moving direction D9 to move the end center point C3 of the detector bar 2211 to the liquid level LL (i.e., adjusting the height of the detector bar 2211 to the liquid surface of the liquid level LL). In this way, the processor 120 starts controlling the detector bar 2211 to collect the sample in the sample bottle b5.

Reference is made to FIG. 23B, and FIG. 23B illustrates a schematic diagram of the detector bar 2211 vertically moving at the moving speed in some embodiments of the disclosure. As shown in FIG. 23B, FIG. 23B also shows the side-view of the detector bar 2211. Continuing with the example of FIG. 23A, when the processor 120 starts controlling the detector bar 2211 to collect the sample in the sample bottle b5, the processor 120 controls the actuator 220 to drive the detector bar 2211 vertically moving at the moving speed v1 along the of the-Z-axis direction (i.e., vertically towards the bottom of the sample bottle b5) in the user coordinate system, so as to continuously collect the sample in the sample bottle b5. By driving the detector bar 2211 vertically moving at the moving speed v1, the sampling control method disclosed herein overcomes the problem of unable to collect the sample due to the liquid level of the sample dropping.

It should be noted that the disclosure utilizes a similar method as described above for sampling other sample bottles, and therefore will not be further described herein.

In summary, the sampling control method and device proposed in the disclosure control the rotation and the horizontal movement of the gripper by automating the rotation and the horizontal movement of the gripper to quickly and accurately clamp the cap of the sample bottle with the gripper. Next, the sampling control method and device proposed in the disclosure determine how far the detector bar should be moved to reach the bottle neck of the sample bottle based on the distance between the gripper and the detector bar, and then remove the cap and moves the detector bar to the bottle neck of the sample bottle. In this way, the sampling control method and device proposed in the disclosure achieve the effect of avoiding human operation and automating the collecting of the sample in the sample bottle. In addition, when the gripper clamps the cap of the bottle, the sampling control method and device as proposed in the disclosure calculate two distances between the gripper and the two interior walls of the chamber to determine how the gripper should be rotated. in this way, the sampling control method and device proposed in the disclosure prevents the gripper from colliding with the chamber when the gripper is rotating. In addition, the sampling control method and device proposed in the disclosure control the movement of the detector bar towards the bottom of the sample bottle at the moving speed during sampling. In this way, the sampling control method and device proposed in the disclosure overcome the problem of unable to collect the sample due to the liquid level of the sample dropping.

While this disclosure has been described by means of specific embodiments, numerous modifications and variations may be made thereto by those skilled in the art without departing from the scope and spirit of this disclosure set forth in the claims.

What is claimed is:

1. A sampling control method for a detection device comprising a chamber and an actuator, wherein the sampling control method comprises:
by a processor, controlling the actuator to drive a gripper on a lift arm in the actuator to rotate centered on a pivot in the actuator from a starting position so that makes a first setting direction of the gripper parallel to a second setting direction of a detector bar on the lift arm;
by the processor, controlling the actuator to drive the gripper horizontally moving to adjust a first horizontal position of the gripper to a horizontal target position in a placement position, wherein the placement position is a position of a sample bottle in the chamber;
by the processor, controlling the actuator to drive the gripper vertically moving to adjust a first vertical position of the gripper to a vertical target position in the placement position, and controlling the gripper to grip a cap of the sample bottle;
by the processor, controlling the actuator to drive the gripper to rotate centered on the pivot so that makes the first setting direction to be perpendicular to the second setting direction;
by the processor, controlling the actuator to drive the detector bar horizontally moving to adjust a second horizontal position of the detector bar to the horizontal target position; and
by the processor, controlling the actuator to drive the detector bar vertically moving to adjust a height of the detector bar to a liquid level, and controlling the detector bar to collect a sample in the sample bottle, wherein the liquid level is a height of a liquid surface of the sample in the sample bottle.

2. The sampling control method of claim 1, wherein the detection device further comprises a washer, wherein, before the step of controlling the actuator to drive the gripper horizontally moving to adjust the first horizontal position of the gripper to the horizontal target position, the sampling control method further comprises:
by the processor, controlling the actuator to drive the lift arm moving to a highest position of the actuator;
by the processor, controlling the actuator to drive the gripper to rotate so that makes the first setting direction to be perpendicular to the second setting direction of the detector bar;
by the processor, controlling the actuator to drive the detector bar moving so that makes the second horizontal position move to a horizontal position at a center point of a bottle neck of the washer; and
by the processor, setting a current position of the gripper as the starting position of the gripper.

3. The sampling control method of claim 1, wherein the step of controlling the gripper to grip the cap of the sample bottle comprises:
by the processor, controlling the gripper to clamp the cap of the sample bottle; and
by the processor, controlling the actuator to drive the lift arm in a vertical direction in a user coordinate system to move the lift arm to a highest position that the lift arm is capable of moving to separate the cap from the sample bottle.

4. The sampling control method of claim 1, wherein the step of controlling the actuator to drive the gripper to rotate centered on the pivot in the actuator so that makes the first setting direction of the gripper to be perpendicular to the second setting direction of the detector bar comprises:
by the processor, calculating a first distance between a position of the gripper and a first interior wall of the chamber and a second distance between the position of the gripper and a second interior wall of the chamber; and
by the processor, controlling the actuator to drive the gripper to rotate in a rotation direction centered on the pivot in the actuator based on the first distance and the second distance, so that makes the first setting direction of the gripper to be perpendicular to the second setting direction of the detector bar.

5. The sampling control method of claim 1, further comprising:
when the height of the detector bar is adjusted to the height of the liquid level, by the processor, controlling the actuator to drive the detector bar vertically moving towards bottom of the sample bottle at a moving speed, so as to continuously collect the sample in the sample bottle.

6. A sampling control device for controlling a detection device, wherein the detection device comprises a chamber and an actuator, wherein the control device comprises:
a memory, configured for storing a placement position of a sample bottle in the chamber and a liquid level of a sample in the sample bottle, wherein the placement position comprises a horizontal target position and a vertical target position of the sample bottle in the chamber;
a processor, coupled to the memory, and configured for executing following steps:
controlling the actuator to drive a gripper on a lift arm in the actuator to rotate centered on a pivot in the actuator from a starting position so that makes a first setting direction of the gripper parallel to a second setting direction of a detector bar on the lift arm;
controlling the actuator to drive the gripper horizontally moving to adjust a first horizontal position of the gripper to the horizontal target position;
controlling the actuator to drive the gripper vertically moving to adjust a first vertical position of the gripper to the vertical target position, and controlling the gripper to grip a cap of the sample bottle;
controlling the actuator to drive the gripper to rotate centered on the pivot so that makes the first setting direction of the gripper to be perpendicular to the second setting direction;
controlling the actuator to drive the detector bar horizontally moving to adjust a second horizontal position of the detector bar to the horizontal target position; and
controlling the actuator to drive the detector bar vertically moving to adjust a height of the detector bar to the liquid level, and controlling the detector bar to collect a sample in the sample bottle.

7. The sampling control device of claim 6, wherein the inspection device further comprises a washer, wherein before the step of controlling the actuator to drive the gripper horizontally moving to adjust the first horizontal position of the gripper to the horizontal target position, the processor is configured for executing following steps:
controlling the actuator to drive the lift arm to a highest position of the actuator;
controlling the actuator to drive the gripper to rotate so that makes the first setting direction to be perpendicular to the second setting direction of the detector bar;
controlling the actuator to drive the detector bar moving so that makes the second horizontal position move to a horizontal position at a center point of the bottle neck of the washer; and
setting a current position of the gripper as the starting position of the gripper.

8. The sampling control device of claim 6, in the step of controlling the gripper to grip the cap of the sample bottle, the processor is configured for executing following steps:
controlling the gripper to clamp the cap of the sample bottle; and
controlling the actuator to drive the lift arm in a vertical direction in a user coordinate system to move the lift arm to a highest position that the lift arm is capable of moving to separate the cap from the sample bottle.

9. The sampling control device of claim 6, wherein in the step of controlling the actuator to drive the gripper to rotate centered on the pivot in the actuator so that makes the first setting direction of the gripper to be perpendicular to the second setting direction of the detector bar, the processor is configured for executing following steps:
calculating a first distance between a position of the gripper and a first interior wall of the chamber and a second distance between the position of the gripper and a second interior wall of the chamber; and
controlling the actuator to drive the gripper to rotate in a rotation direction centered on the pivot in the actuator, based on the first distance and the second distance, so that makes the first setting direction of the gripper to be perpendicular to the second setting direction of the detector bar.

10. The sampling control device of claim 6, the processor is further configured for executing following steps:
when the height of the detector bar is adjusted to the height of the liquid level, controlling the actuator to drive the detector bar vertically moving towards bottom of the sample bottle at a moving speed, so as to continuously collect the sample in the sample bottle.
